(19) United States
(12) Patent Application Publication
(10) Pub. No.: US 2006/0007169 A1
(43) Pub. Date: Jan. 12, 2006

(54) Self-encoding control interface bezel system

(76) Inventors: Michael S. Robbins, Los Angeles, CA (US); Chester A. Wyche JR., Valencia, CA (US); Victor M. Avendano, Burbank, CA (US); Raymond G. Bond, Long Beach, CA (US)

Correspondence Address: HOGAN & HARTSON L.L.P., 500 S. GRAND AVENUE, SUITE 1900, LOS ANGELES, CA, 90071-2611, US

(21) Appl. No.: 10/861,225

(22) Filed: Jun. 4, 2004

(51) Int. Cl. G09G 5/00

(52) U.S. Cl. 345/173

(57) ABSTRACT

A control interface is disclosed that includes a display screen, a touch screen disposed on the display screen, a processor and memory electrically connected to the display and the touch screen, and a bezel, which is of a particular type, disposed over the touch screen. The processor may be configured according to any one or more different types of bezels.

### BACKGROUND OF THE INVENTION

Touch screens and mechanical keys with programmable functions (mechanical soft keys), by virtue of their programmability, provide a high level of flexibility for the user interfaces of numerous systems and devices. Display/touch screens allow graphic displays of buttons that can be placed anywhere on the display to actuate any desired function or input.

Mechanical soft keys, which are typically disposed on a bezel surrounding a display area, are somewhat less flexible. The keys themselves are mechanical. However, like touch screen buttons, the functions that can be assigned to them are unlimited and often can change dynamically.

For some user interfaces, however, it is also desirable to provide to mechanical soft keys the flexibility that touch screen buttons have with respect to their locations. That is, it is desirable to provide a variety of layouts for mechanical keys on a user interface. For example, in the home entertainment system context, users often have different needs and preferences for their home entertainment control systems in part because these systems may control a variety of different products and combinations of products. The user often operates such systems from a control panel inset into a wall for easy access. The control panel may be designed for programming flexibility to accommodate the variations in user preferences. Often however, having some additional flexibility in the locations and functions of mechanical keys is desired.

Unfortunately, to provide that additional measure of flexibility, an entirely different model of control panel would have to be provided for each variation. In a control user interface, one cannot readily move mechanical buttons from one area of the interface to another. Mechanical and electrical elements beneath the buttons, generally part of a printed circuit board, are set or fixed in place according to the design of the user interface. To move or rearrange the mechanical keys of a user interface may require completely redesigning the circuit board or at least partially redesigning some of the underlying mechanical and electrical elements of the user interface. The necessity of such design efforts makes providing the desired flexibility commercially unfeasible.

U.S. Pat. Nos. 5,579,002 and 5,729,222 issued to Iggulden et al., which are hereby incorporated by reference as though fully set forth herein, disclose a user configurable interface in which a user can arrange keys (i.e., buttons) on a control device perforated with a pattern of slots to accept the keys. Projections on the backs of the keys are unique for each key and define a function for each key. While the patents disclose some interchangeability of mechanical keys, the keys are movable only to slots provided on the control panel, and so the control panel's flexibility in this respect is limited according to the locations of slots that it provides. As each of the keys specifies a function, the patents essentially disclose a mechanical technique for programming the functions of a control interface.

A need exists, therefore, for systems and methods that provide varieties of arrangements of mechanical soft and hard function keys without the prohibitive cost of creating an entirely redesigned control interface for each arrangement.

### SUMMARY OF THE INVENTION

One aspect of the present invention provides systems and methods for using a variety of bezels, incorporating numerous button arrangements, with a single control panel that includes a display and a touch screen.

In a second aspect, the present invention is a control interface comprising a display screen, a touch screen disposed on the display screen, a processor electrically connected to the display, the touch screen and a memory, and a bezel disposed over the touch screen. The memory preferably stores one or more bezel type codes and each bezel type code corresponds to data regarding a different type of bezel. The bezel preferably includes a plurality of buttons and a plug projecting from the bezel and contacting a socket electrically connected to the processor. The plug thereby communicates information via the socket to the processor regarding the bezel. Preferably, the information communicated identifies the bezel as a bezel type among a plurality of bezel types, and the processor executes in accordance with the bezel type.

In a third aspect, the present invention is a control system comprising a plurality of electronic components and a control interface electrically connected to each of the plurality of electronic components. The control interface includes a display screen, a touch screen disposed on the display screen, a processor electrically connected to the display, the touch screen and a memory, and a bezel disposed over the touch screen. The memory preferably stores bezel type codes and each bezel type code corresponds to data regarding a different type of bezel. The bezel preferably includes a plurality of buttons and a plug projecting from the bezel and contacting a socket electrically connected to the processor. The plug thereby communicates information via the socket to the processor regarding the bezel. Preferably, the information communicated identifies the bezel as a bezel type among a plurality of bezel types, and the processor executes in accordance with the bezel type.

In a fourth aspect, the present invention is a control interface comprising a display screen, a touch screen disposed on the display screen, a processor electrically connected to the display and the touch screen, a memory connected to the processor, and a bezel disposed over the touch screen and having a configuration recognized by the processor. The processor is preferably configurable according to any one of a plurality of different types of bezels.

In a fifth aspect, the present invention comprises a bezel for a display device including a frame having an exposed side and a contact side opposite the exposed side, a plurality of buttons disposed on the frame, and a plug projecting from the contact side of the frame and identifying the bezel as a bezel type among a plurality of bezel types. A user preferably actuates a plurality of buttons on the exposed side of the frame and communicates input information via the contact side of the frame. Preferably, the plug identifies the bezel as a bezel type based on a configuration of prongs on the plug.

In a sixth aspect, the present invention comprises control interface including a display screen, a touch screen disposed on the display screen, a processor electrically connected to the display and the touch screen, a memory connected to the processor; and a bezel. The bezel preferably includes a frame and a button disposed on the frame. The frame is preferably disposed over the touch screen such that at least part of the frame is disposed outside the perimeter of the touch screen. The button comprises a touch pad, a contact point and lateral extension connecting the touch pad and the contact point, the button being positioned at least partially outside the perimeter of the touch screen, such that actuating the button causes the contact point to contact the touch screen.

### BRIEF DESCRIPTION OF DRAWINGS

The following discussion may be best understood with reference to the various views of the drawings, described in summary below, which form a part of this disclosure.

FIG. 1 is a block diagram of an electronic control system 100 that serves as a preferred context for application of the various embodiments of the invention disclosed herein.

FIG. 2 is a block diagram depicting a preferred embodiment of a control user interface, such as the control user interface depicted generally in FIG. 1.

FIGS. 3A and 3B are diagrams depicting a front view and a partial back view of a preferred embodiment of a bezel such as the bezel shown in FIG. 2.

FIG. 3C is a diagram depicting a preferred embodiment of a bezel of a different type than the bezel of FIGS. 3A and 3B.

FIG. 3D is a diagram depicting a preferred embodiment of a bezel of a different type than the bezel depicted in FIGS. 3A and 3B or the bezel depicted in FIG. 3C.

FIG. 4 depicts an example of a bezel with no mechanical buttons.

FIG. 5 depicts an example of a bezel that covers the entire touch screen area with buttons.

FIGS. 6A, 6B and 6C are diagrams depicting perspective views of alternative embodiments of three notches that project from the backside of a bezel such as that shown in FIG. 2.

FIGS. 6D and 6E are diagrams depicting perspective views of a preferred embodiment of a plug that projects from the backside of a bezel such as that shown in FIG. 2 and a receiving socket.

FIG. 7A is a diagram depicting a front view of a button defined by a void on three sides of the button and a tab connecting the button to the rest of a bezel.

FIG. 7B is a diagram depicting a front view of a button, which is defined by a button frame and a notch projecting from the backside of the button.

FIG. 7C is a diagram depicting a front view of another embodiment of a button, which is defined by a notch projecting from the backside of the button and a button label, marked region, and/or outline imprinted on the front of the button.

FIG. 8 is a flow diagram depicting a preferred embodiment of a method of configuring a control user interface such as the control user interface depicted in FIG. 2.

FIG. 9 is a flow diagram depicting a preferred embodiment of a method of registering a particular button arrangement for a bezel.

FIG. 10A depicts an example of a bezel that includes buttons that are arranged about the left and right periphery of the bezel and outside the perimeter of a touch screen.

FIG. 10B depicts an example of an embodiment of a bezel 1010 that includes a button 1012 with a lateral extension 1016 such as may be provided in the bezel of FIG. 10A.

FIG. 10C depicts second example of an embodiment of a bezel that includes buttons having an actuator connected by a lateral extension such as may be provided in the bezel of FIG. 10A.

### DETAILED DESCRIPTION OF THE PREFERRED EMBODIMENTS

The present invention is now described more fully with reference to the accompanying drawings, in which different embodiments of the invention are shown. This invention may, however, be embodied in many different forms and should not be construed as limited to the embodiments described herein.

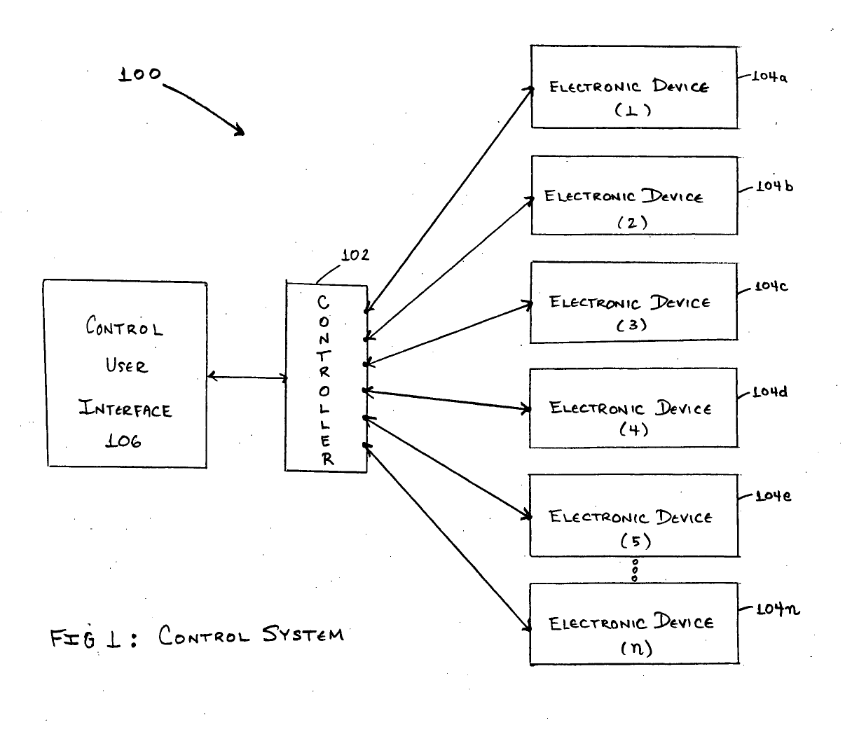

FIG. 1 is a block diagram of an electronic control system 100 that serves as a preferred context for application of the embodiments disclosed herein. The control system 100 preferably includes a controller 102, one or more electronic devices 104a, 104b, . . . 104n and a control user interface 106. The controller 100 is preferably electrically connected to each of the electronic devices 104a, 104b, . . . 104n and to the control user interface 106. However, alternatively, the controller 100 may be connected to the other elements of the control system 100 by any convenient means for communicating data over short distances, specifically the range of distances common between rooms of a home or office. For example, a wireless communication system between the components and the control user interface may be employed.

The typical application for such a control system 100 is a multi-room home entertainment system. In this context, the electronic devices 104a, 104b, . . . 104n may be, for example, one or more television receivers, VCRs, DVD players, and/or satellite and audio receivers. The devices may also be other electronically controlled appliances such as motorized curtains or electronically controllable fireplaces. In the typical home entertainment application, the control user interface 106 is preferably an in-wall panel that enables both user input and the display or other output of information, such as audio, to the user. As such, the controller 100, in one aspect serves as a multiplexing device for enabling the user to control potentially numerous electronic devices from a single location.

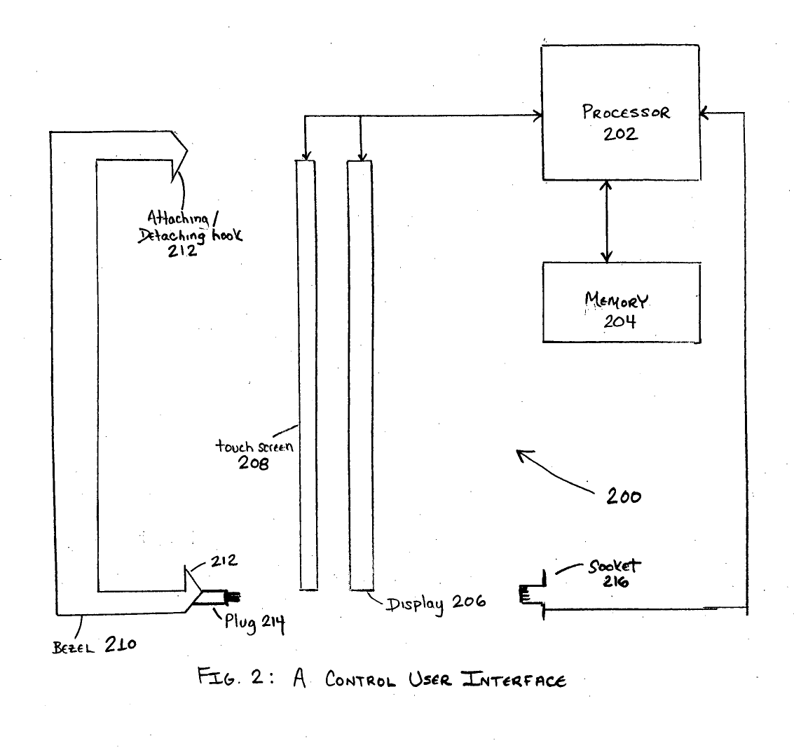

FIG. 2 depicts a block diagram of a preferred embodiment of a control user interface 200, such as the control user interface 106 depicted generally in FIG. 1, for enabling a user to input and receive information regarding the system 100 under control. The control user interface 106, 200 preferably includes a processor 202, a memory 204 a display screen 206, a touch screen 208, and a bezel 210. FIG. 2 depicts side views of the display screen 206, the touch screen 208 and the bezel 210. The processor 202 may a microprocessor that is part of a standard computer (like those manufactured by IBM® or Apple®) or a circuit board customized for the control user interface. The processor 202 preferably executes software to provide flexibility in programming, modifying and upgrading the system, and thereby improve the operability of the control user interface 106, 200 over time. Alternatively, the processor 202 may be any type of processor or processors that enable dynamic configuration of the control user interface 106, 200 as described herein.

Thus, as used throughout, the term “processor” refers to a wide variety of computational devices or means including, for example, using multiple processors that perform different processing tasks or having the same tasks distributed between processors. The processor(s) may be general purpose CPUs or special purpose processors, such as those often used in digital signal processing systems. Further, multiple processors may be implemented, if appropriate. Some or all of the processing may be alternatively implemented with hard-wired circuitry such as an ASIC, FPGA or other logic device.

The memory 204 is electrically connected to the processor and preferably operates in conjunction with the processor 202 to enable the implementation of the embodiments of the control user interface 106, 200 described herein. Thus, as used throughout, the term “memory” refers to any storage medium, such as a semiconductor memory, that is accessible to a processor that meets the memory storage needs for the control user interface 106, 200 or its components.

The display screen 206 is electrically connected to and controlled via the processor 202. As such, the display screen 206 may be any display device, such as a cathode ray tube (CRT) or liquid crystal display (LCD). Disposed over and preferably in contact with the display side of the display screen 206 is the touch screen 208. The touch screen 208 may be any touch screen as is commonly known in the art that detects contact on the screen based on the location of the contact. In one embodiment, the touch screen is a resistive touch screen. In other embodiments, the touch screen 208 is another type of x-y detection screen that detects multiple contacts on different locations of the touch screen 208 at the same time, such as a scanning-based touch screen.

In the example of the bezel 210 shown in FIG. 2, the bezel 210 is generally disposed over and frames the touch screen 208. That is, in one embodiment, the bezel 210 preferably includes an open or transparent interior portion to enable a user to view the display screen 206 through the touch screen 208. The bezel 210 preferably includes attaching/detaching hooks or clips 212 as shown in FIG. 2 or includes any other convenient mechanism for removing and installing the bezel onto the control user interface 200, 106. The bezel, for example may alternatively be snapped into or screwed into the control user interface. The bezel 210 preferably acts to hold the display screen 206 and the touch screen 208 in place and in contact with each other, and may also cover any gaps between the display screen 206 and a wall surface.

In one embodiment, the bezel 210 includes a plug 214 that extends from one of the hooks of the bezel 210, 300. The plug 214 functions as a tag for communicating to the processor 202 via a receiving socket 216 the type of bezel 210 that is attached to the control interface 106. In one embodiment, when the bezel 210 is installed onto the control user interface 106, 210, the plug 214 engages the socket 216, which is preferably electrically connected to the processor 202. In other embodiments, the plug 214 and socket 216 may be configured on other ways and orientations, such that for example, the plug 214 extends from another part of the bezel 210 and the socket 216 is appropriately positioned to engage it. The bezel 210 is preferably formed of a hard plastic, although the bezel 210 may be formed of other, preferably electrically insulating materials.

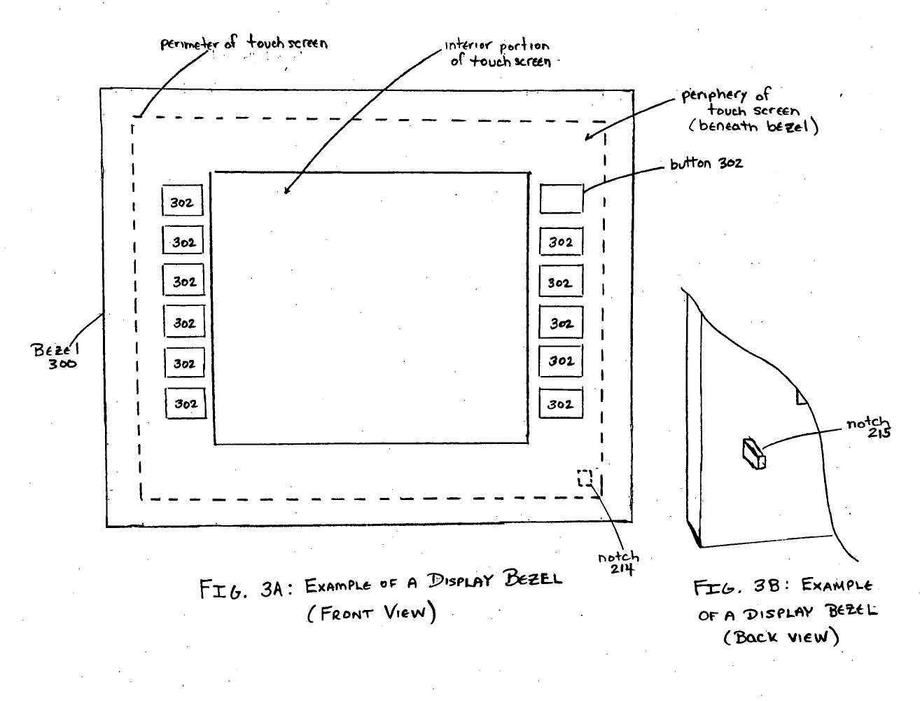

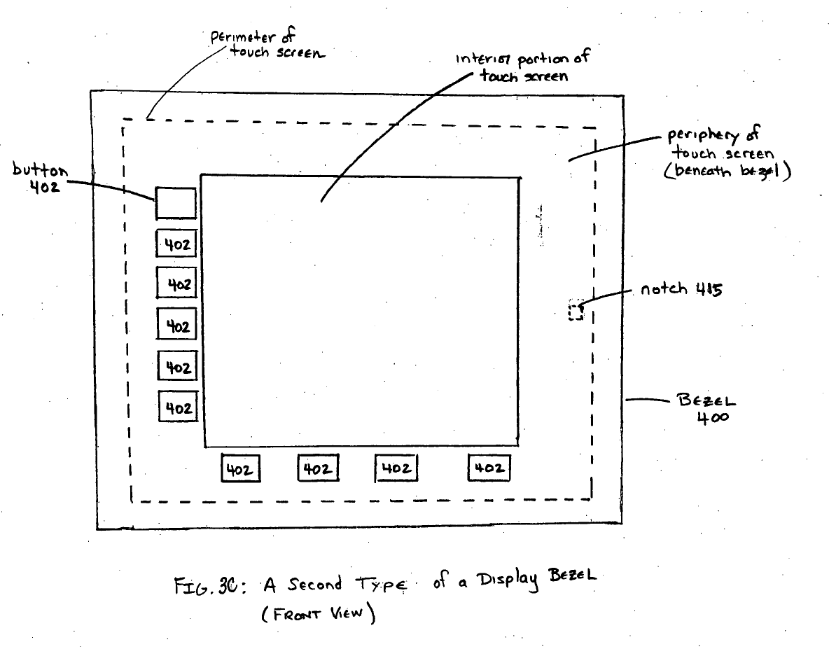

FIGS. 3A and 3B depict a front view and a partial back view of a bezel 300 such as the bezel 210 shown in FIG. 2. FIG. 3A depicts an arrangement of buttons 302 on the left and right sides of the face of the bezel 210, 302. The particular arrangement of buttons is arbitrary and is shown to reflect one desirable arrangement of buttons among preferably many desirable arrangements.

The interior portion of the bezel 210, 300 is open to enable a user to view the display screen 206 and preferably to access the touch screen 208 directly. A portion of the face of the bezel 210, 300 also covers the periphery of the touch screen 208 such that actuating (e.g., pressing) any of the buttons causes a contact with the touch screen, and thereby, a detection of the button's actuation.

FIG. 3A depicts the location of a notch 215 according to an alternative embodiment in lieu of the plug 214/socket 216 configuration, and FIG. 3B actually depicts the notch 215 protruding from the back (contact) face of the bezel 210, 300. Like the plug 214, the notch 215 functions as a tag for communicating to the processor 202 the type of bezel that is attached to the control interface 106. Unlike the plug 214 however, the notch 215 communicates with the processor 202 via the touch screen 208.

Alternatively, the bezel tag (information) is communicated to the processor 202 manually such as by entering a code using the available buttons on the bezel 210 or using by using another external device, such as a PDA or personal computer, which may be connected to the processor 202 while the control system 100 is being installed. The processor 202 and/or memory 204 preferably store information regarding numerous types of bezels (i.e., bezel types) mapped according to the bezel tag information that is communicated to the processor 202.

As another alternative, instead of communicating a bezel tag to the processor 202 from which the processor 202 would determine the configuration for the bezel 210 based on bezel configurations stored in memory 204, the complete configuration for the bezel 210 is communicated to the processor 202. In this embodiment, an installer may transmit, for example, a configuration file from a PDA or personal computer to the processor 202 for the bezel 210 that is being installed. Thus, in this embodiment, the processor 202 preferably does not retain such bezel configuration files or the codes that correspond to such files. Rather, the processor 202 receives the configuration file that it is transmitted to it (i.e., “injected”), reads the configuration file, and responds according to the configuration. In this embodiment, the control user interface 106 is fully programmable such that it can be readily made compatible with a variety of types of bezels once it is provided the necessary information about the bezel, such as in the form of a configuration file, script, executable code, etc.

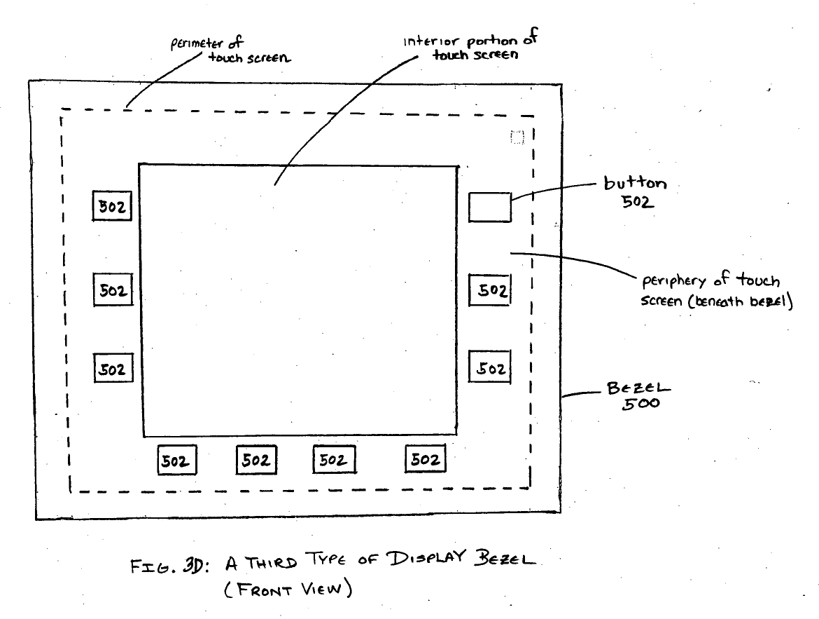

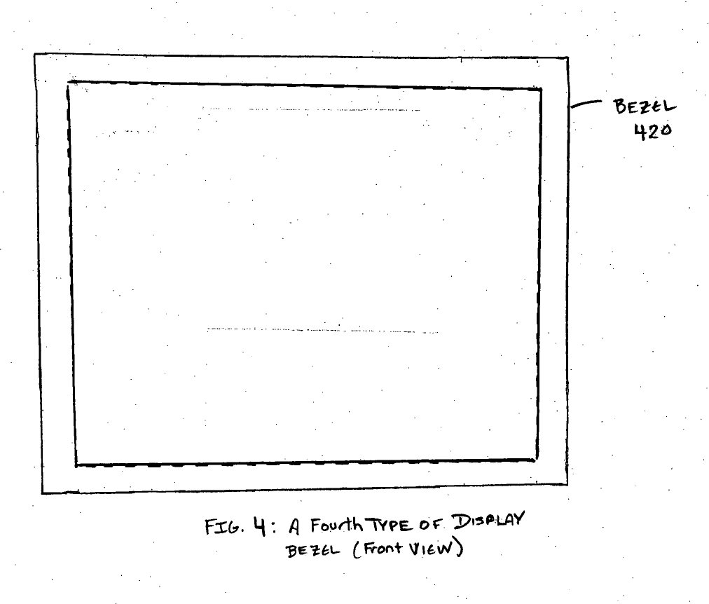

Preferably, a bezel 210 of a particular type is at least partially defined by the layout of the buttons, if any, on the bezel 210, and optionally, the function and/or value that each button enables a user to actuate. Thus, FIG. 3C depicts a bezel 400 of a different type than the bezel of FIG. 3A. The bezel 400 is of a different type because of the difference in the layout of its buttons. Similarly, FIG. 3D depicts a bezel 500 of a third type, based on yet another arrangement of buttons 502. Distinctions between bezel types need not be based on an arrangement of buttons however. For example, FIG. 4 depicts an example of a bezel 420 with no mechanical buttons. In contrast, FIG. 5 depicts a bezel 470 that covers the entire touch screen area with buttons 472. Furthermore, two bezels with the same arrangement of buttons may be of different types based on the differences in the functions that are performed by each button. Alternatively, distinctions in bezel types may be based on or include other factors, such as the color and/or aesthetic design of the bezel.

However bezel types are distinguished, the processor 202 preferably includes information specifying all of the bezel types, which allows the processor 202 to respond accordingly when it receives the bezel type information such as from the bezel tag encoded via the plug 214 on an installed bezel. The plug 214 preferably possesses an electrical contact-based feature that communicates the bezel type information via the socket 208 to the processor 202. In the alternative embodiment of a notch 215 that contacts a touch screen 208, the notch 215 also preferably possesses a contact based feature.

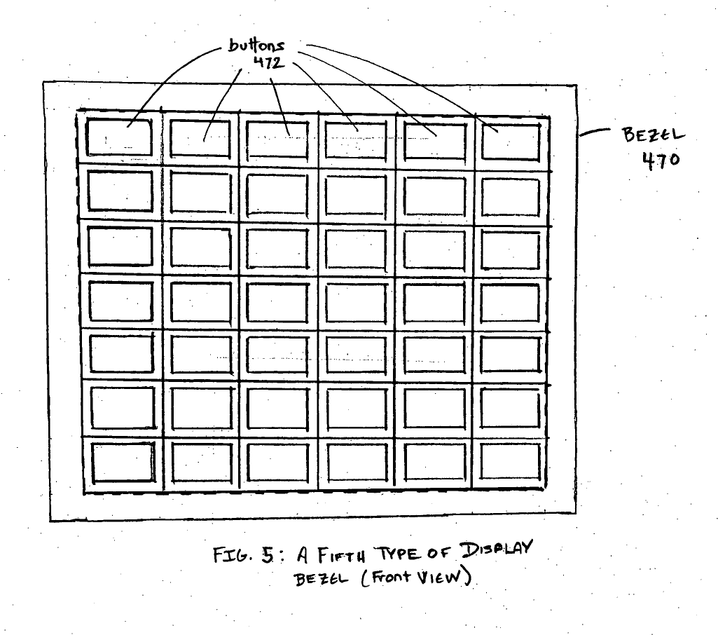

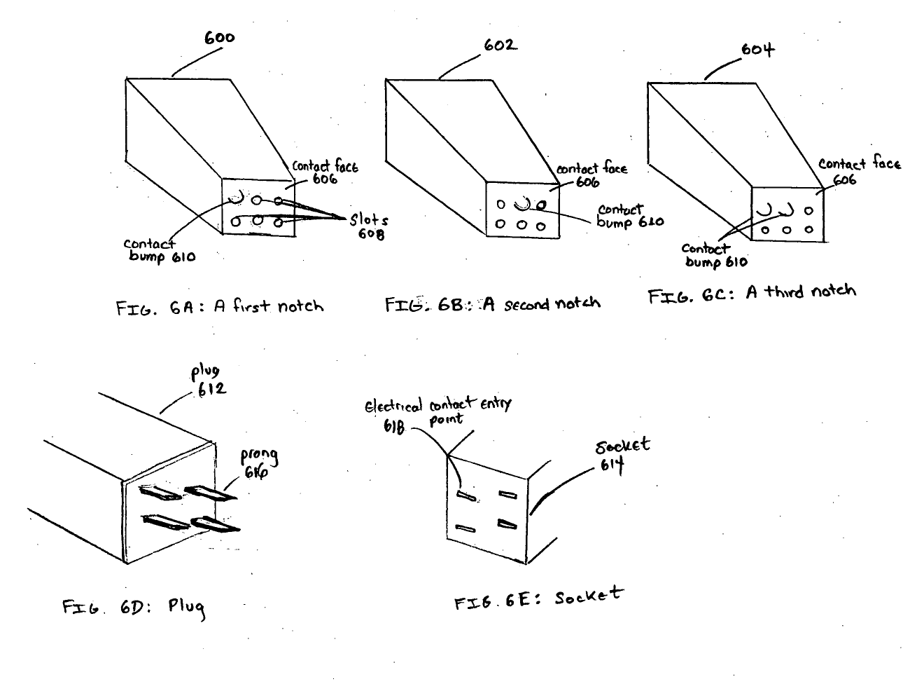

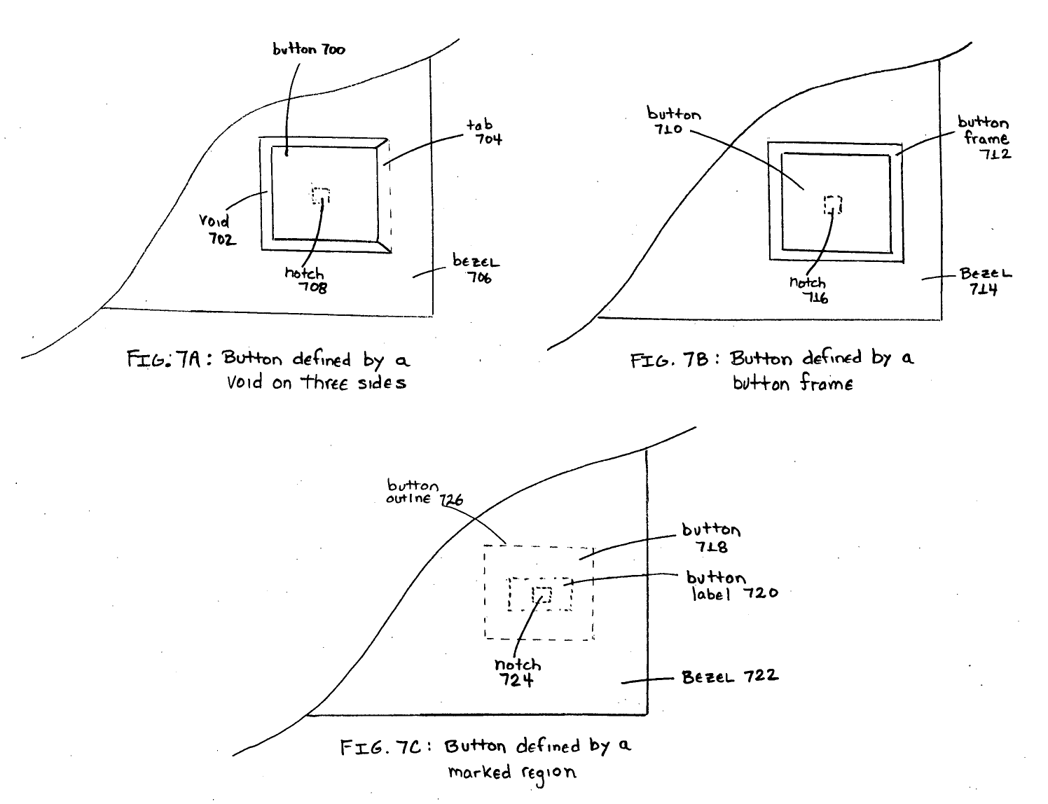

The bezel tag may take one or more of a variety of forms. As shown in FIGS. 6D and 6E, in the embodiment employing a plug 214, 612 and socket 216, 614, the plug 214, 612 preferably has a set (e.g., four as shown) of prongs 616, where each prong 616 may enter an electrical contact entry point 618 in the socket 614. A bezel type is preferably identifiable based on the number and location of the prongs 616 that engage the electrical contact points in the socket 614. That is, the particular set of contacts made by the prongs 616 in the socket identifies each type of bezel. The plug 612 and socket 614 may have or less than four prongs and electrical contact entry points as necessary. For example, in FIGS. 6A and 6B the four prongs 616 provide for four distinct contact points with the socket 614, potentially providing for the communication of up to 2⁴ or 16 distinct bezel types. If more than sixteen bezel types are offered, then the plug 612/socket 614 configuration would provide five or more plugs and electrical contact points respectively.

In a preferred embodiment employing the touch screen 208 as the contact interface for communicating the bezel tag, the notch 215 preferably includes a spring or a latch such that notch 215 makes only a brief contact with the touch screen, and the bezel tag may be based on the location of the notch 215. For example, in FIGS. 3A and 3B, the notch 215 is positioned in the lower corner of the bezel 210, 300, whereas in FIG. 3C, the notch 415 is located near the vertical midpoint on the right side of the bezel 400. These figures depict a bezel tag in which the location of the contact on the touch screen 210 by the notches 215, 415 communicates to the processor 202 enough information to identify the bezel type for the bezel 300, 400.

Alternatively, rather than relying on the location of a single notch 215, 415 to communicate the bezel type to the processor 202, multiple notches may be employed, which via their multiple contacts with the touch screen 208, communicate a bezel type. As yet another alternative, a single notch 215 is used that includes multiple or alternative contact points on the tip end (i.e., touch screen contact face) of the notch 215, much like embodiment in which the plug 214 designed to engage the socket 216. For example, FIGS. 6A, 6B and 6C depict three notches 600, 602, 604 with minor differences at the contact face 606 of the notches 600, 602, 604. Each of the notches 600, 602 and 604 include, by way of example, six slots 608 for contact with the touch screen 208. However, in FIG. 6A, for example, notch 600 includes a contact bump or dimple 610 only in the upper left corner of the notch's contact face. In FIG. 6B, notch 602 includes a contact bump 610 only in the upper middle slot of the notch's contact face. In FIG. 6C, notch 604 includes contact bumps 610 at both the upper left and upper middle slots of the notch's contact face. As with the plug 214, while each notch 600, 602, 604 preferably protrudes from the back of the bezel 210 at same location, the slots 608 provide for six distinct contact points with the touch screen 208, potentially providing for the communication of up to 2⁶ or 64 distinct bezel types. One skilled in the art may readily employ other embodiments for using contact-based features, such as level of contact pressure, etc., to communicate bezel type information to the processor 202 via the touch screen 208.

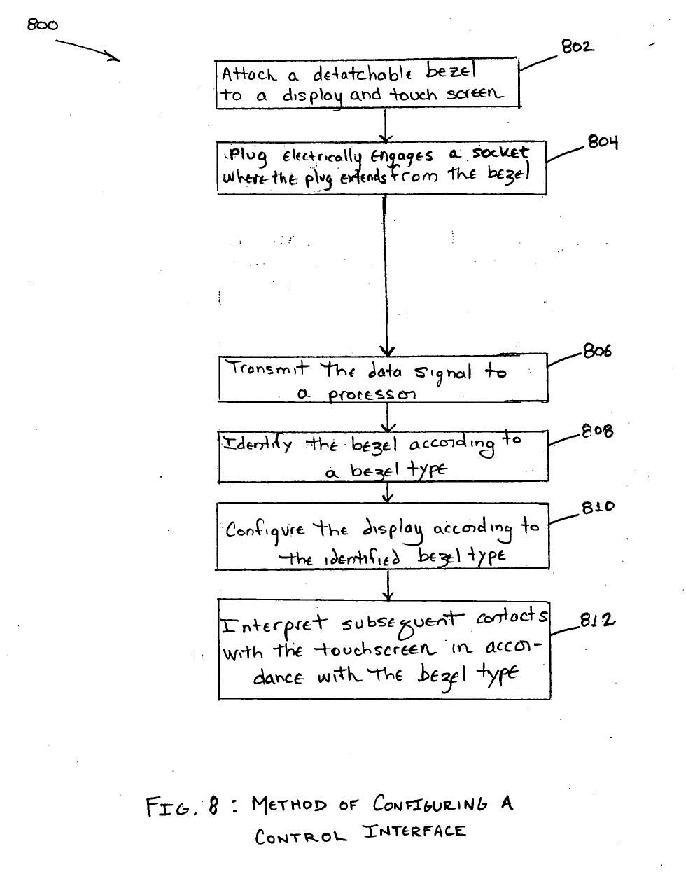

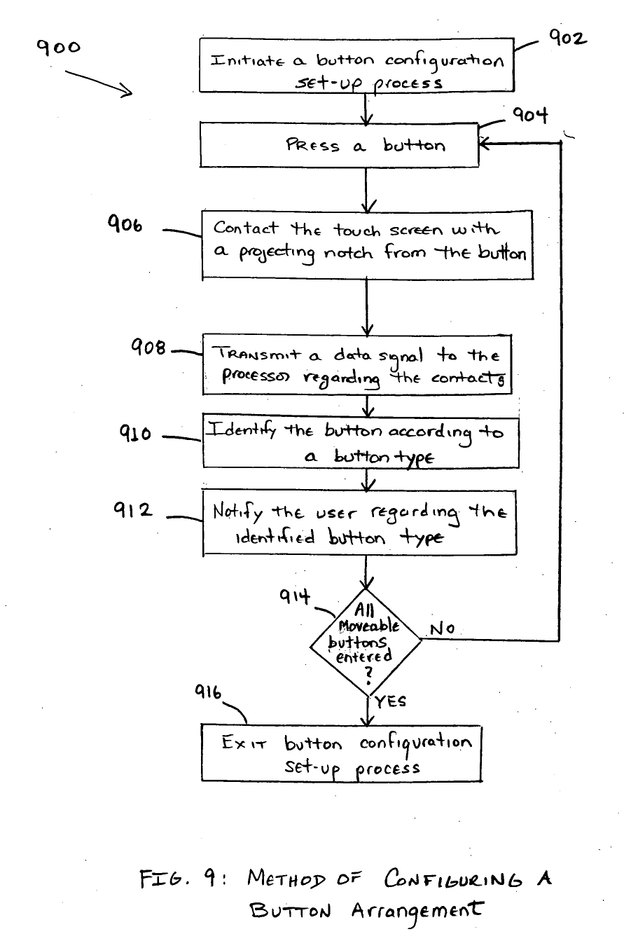

FIGS. 7A, 7B and 7C depict alternative embodiments for implementing buttons on a bezel, such as the bezels 210, 300, 400, 420, 470, 500 of FIGS. 2 through 5. FIG. 7A depicts a front view of a button 700 defined by a void 702 on three sides of the button 700 and a tab 704 connecting the button 700 to the rest of a bezel 706 (only a portion of the bezel 706 is shown) on the fourth side of the button 700. The bezel 706 and the button 700 are preferably formed of a hard plastic. The tab 704 preferably is formed of a plastic with some flexibility to allow the user to press the button 700 without having to exert undue pressure to actuate the button 700. In a preferred embodiment, the back of the button 700 includes a notch 708, similar to notch 214 of FIGS. 3A through 3D, that contacts the touch screen 208 when the button 700 is pressed. Preferably, the bezel 706, button 700, tab 704 and notch 708 are formed of the same plastic material and as part of a single mold. As such, the tab 712 may be flexible by virtue of being thinner than (in terms of depth from the front to the back of the bezel 706) than the button 700 or the bezel 706. The notch 708 preferably further includes a rubber tip that cushions the contact with the touch screen 208. Preferably, the processor 202 processes the contact with the touch screen 208 based on the area of the contact on the touch screen 208 that has been prescribed for the button 700.

FIG. 7B depicts a front view of a button 710, which is part of a bezel 714. The button 710 is defined by a button frame 712 and a notch 716 projecting from the backside of the button 710 that contacts the touch screen 208 when the button 700 is pressed. Like with the embodiment described above, all of the elements, i.e., the bezel 714, the button 710, the frame 712 and the notch 716 are formed of the same plastic material and as part of a single mold. Furthermore, like the tab 706 described above, the button frame 712 preferably is flexible to allow the user to press the button 710 and cause the notch 716 to contact the touch screen 208. The button frame 712 may be formed of a thin section of plastic that provides such flexibility.

FIG. 7C depicts a front view of another embodiment of a button 718, which is part of a bezel 722. The button 718 is defined by a notch 724 projecting from the backside of the button 718 and a button label 720, marked region, and/or outline 726 imprinted on the front of the bezel 722 to indicate to a user the location and preferably the function performed by pressing the button 718. In this embodiment, the bezel 722 and button 718 are preferably formed of the same material, such as a soft plastic, to permit a user to flex the button into an actuating position such that the notch 724 contacts the touch screen 208. Optionally, the button 718 does not include notch 724 such that contact with the touch screen 208 when the button 718 is pressed is based on the direct pressure of the user's finger separated only by the soft plastic, or other flexible material of the button 718.

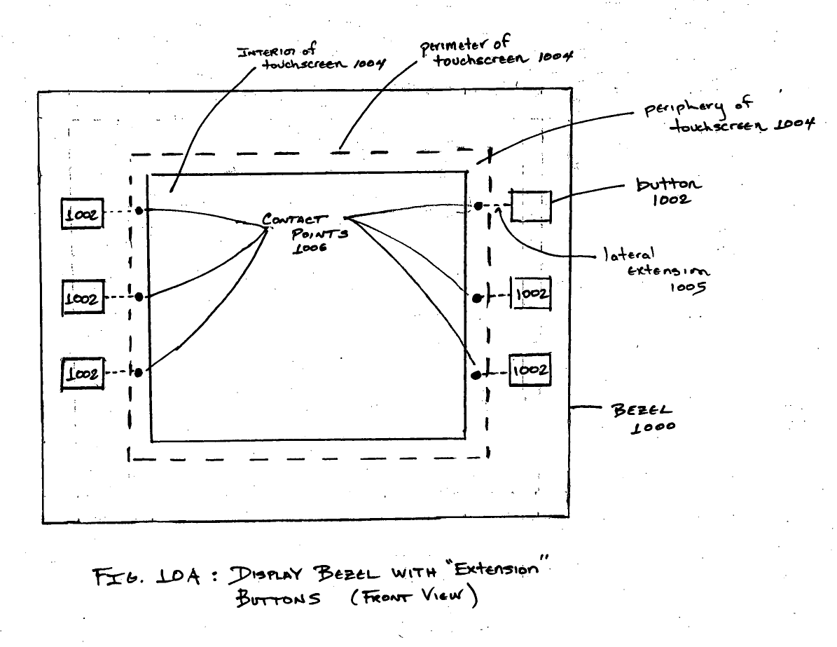

FIG. 8 is a flow diagram depicting a preferred embodiment of a method 800 of configuring a control user interface such as the control user interface 106, 200 referenced in FIGS. 1 and 2 and having the components depicted in FIG. 2. In a first step 802, a bezel 210 of a particular type, among multiple predetermined types, is attached to a display 206 and touch screen 208, which form part of the control user interface 106, 200. The bezel 210 may be secured by any of a variety of means including snap in and out contact points, attaching/detaching hooks, clips, etc. The bezel 210 may also be screwed into place. Preferably, securing the bezel to the display 206 and touch screen 208 facilitates securing together the interface elements (i.e., the display 206, the touch screen 208 and the bezel 210) in a sandwich configuration.

In a next step 804, upon securing the bezel 210 in place, a plug 214 on the bezel engages a socket that is electrically connected to a processor. As discussed above, one or more features of the engagement of the plug 214 with the socket 216 encode information to be communicated from the bezel 210 to the socket 216. The information is essentially encoded in the location and number of prongs 616 that engage the socket 216.

In a next step 806, the socket 216 electrically communicates a signal to the processor 202 containing information about the contact(s), (e.g., the location of the contact(s)).

Then, in a next step 808, the processor 202 interprets the signal. In one embodiment, the processor 202 receives the data signal and applies the data from the signal to a look-up table in memory 204 that matches the contact information to a type of bezel. Preferably, the processor 202 is in an initialization state such that it is configured to await and process the signal into an identification of a bezel that has just been installed.

In a next step 810, the processor 206 preferably configures itself and the display 206 in accordance with the identified bezel type. Thus, based on the identification of the bezel type, the processor preferably transmits signals to the display 206 to depict graphics on the display 206 that correspond to the identified bezel type. For example, the processor 202 preferably includes information regarding the location and function of each of the buttons on the installed bezel. Consequently, the processors may transmit signals to the display 206 to display soft function labels for those buttons adjacent to one or more of the buttons. The processor 202 may also transmit signals to the display 206 to instruct the display to depict additional buttons on the display (touch screen buttons) that correspond to additional functions and/or values that are not provided by buttons on the bezel itself. Furthermore, the processor 202 may transmit signals instructing the display 206 to display a background color or graphic that matches the artistic style of the installed bezel 210. The display 206 preferably receives these various signals and displays graphics and text as instructed. In this step 810, other processes for initializing the processor 202 in accordance with the installed bezel based on its identified bezel type are performed. For example, the processor 202 may load from the memory 204 other data regarding the bezel 210 including the locations and functions ascribed to the various buttons.

Upon completing the initialization of the processor 202 with respect to the installed bezel, in a next step 814, the processor 202 enters an operational state in which it is ready to receive commands from the touch screen 208. As such, the processor 202 interprets subsequent contacts with the touch screen 208 in accordance with a specification that defines the bezel type for the installed bezel 210.

In another embodiment, a bezel, such as the bezels depicted in FIGS. 2 through 5, includes buttons that are interchangeable within button slots. In this embodiment, buttons preferably are snapped into or out of button slots on the bezel. Furthermore, the buttons may include function labels on their front faces. The purpose of providing such interchangeability is that each button preferably has a particular button type that corresponds to a function and/or value that pressing the button initiates. The button type (i.e., function and/or value) is preferably encoded on a button tag (e.g., notch) that protrudes from the back of the button. Thus, while the bezels in these described embodiments include notches that encode a bezel type, in the present embodiment, the buttons of a particular bezel type also each include a button type. Preferably, the encoding of the button type on the notch of a button is implemented using the one or more of the designs used for distinguishing bezel types.

Configuration of a bezel of a type that includes interchangeable buttons preferably includes the steps of the method 800 of FIG. 8. However, the configuration of such a bezel preferably includes additional intermediate steps for configuring a particular button arrangement. For example, in configuring a button arrangement, a step is preferably performed in which a particular button arrangement is applied to a bezel before the bezel is attached to the display and touch screen. Buttons are preferably snapped into and out of slots until a desired customized arrangement of buttons is made. Then, preferably, after the processor has identified the bezel according to a particular bezel type, a process is initiated in which each of the buttons are identified, button-by-button, by button type.

FIG. 9 is a flow diagram depicting a preferred embodiment of a method 900 of configuring or registering a particular button arrangement for a bezel. The method 900 generally includes steps similar to those taken for identifying a bezel type. The method 900 preferably proceeds after the processor for the control interface has identified the bezel as a particular bezel type and has, optionally, at least partially configured the display according to aspects of the bezel type that do not relate to the yet-to-be-configured button arrangement. For example, the processor may have configured the display with the appropriate background color corresponding to the color of the bezels, displayed function labels next to any buttons on the bezel that are not interchangeable with other buttons, or displayed buttons actuated by the touch screen that correspond to additional functions and/or values not provided by the bezel's mechanical buttons.

Preferably, in a first step 902 in the method 900 of configuring a button arrangement, a button configuration set-up process is initiated. The initiation may occur by default based on the processor's identification of the bezel type and its expectation for button arrangement data. Alternatively, the process 902 may be user-initiated.

In a next step 904, an installed interchangeable button is pressed. Then, in next step 906, a notch projecting from the back of the button contacts the touch screen. The notch preferably has a contact face with dimples or bumps as depicted with the notches of FIGS. 6A, 6B and 6C which impart information based on the number and locations of the contacts with the touch screen. Then in a next step 908, a data signal is transmitted from the touch screen to the processor regarding the contacts.

In a next step 910, the processor interprets the data regarding the contacts to determine the button type of the button that was pressed. As with the processor's determining bezel type, the processor may use a look-up table to determine button types. In a next step 912, the processor preferably notifies the user that the processor has identified the button as a particular button type. The notification may be in the form of a signal to the display to display a label adjacent to the pressed button that corresponds to the function and/or value that pressing the button initiates. Then, a check 914 is made, for example, via a signal from the user or by the processor itself, regarding whether all of the configurable buttons have been identified. If not all of the configurable buttons on the bezel have been identified, then the user may perform the step 904 of pressing another button, and having the processor identify that button and notify the user accordingly. If the processor has registered the last of the configurable buttons, then in a next step 916, the processor exits the button configuration set-up process. Alternatively, the user may signal to the processor to exit the configuration process.

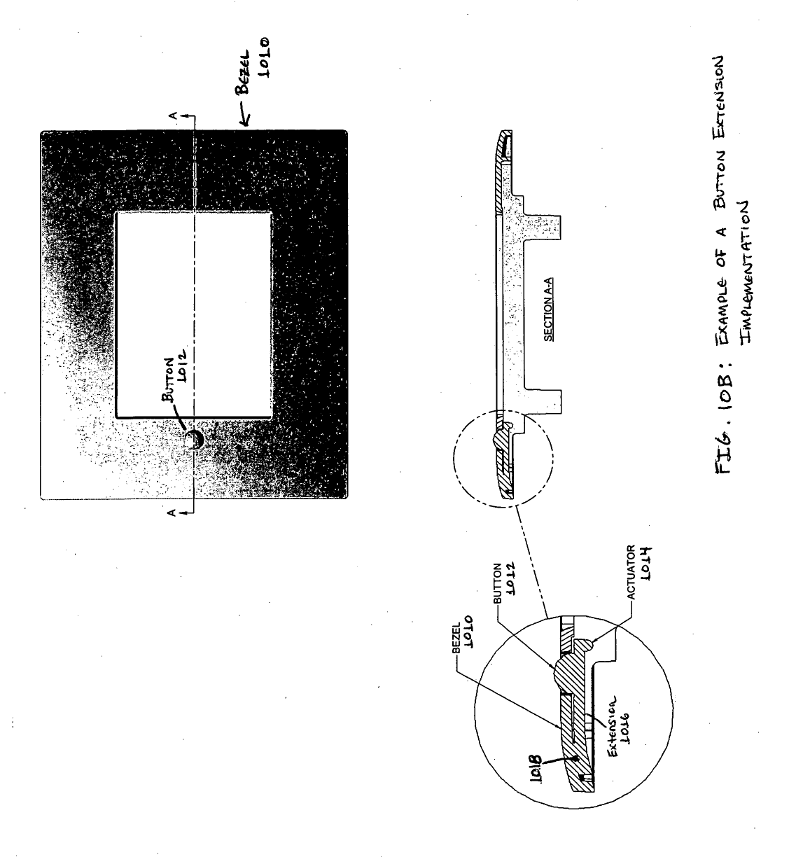

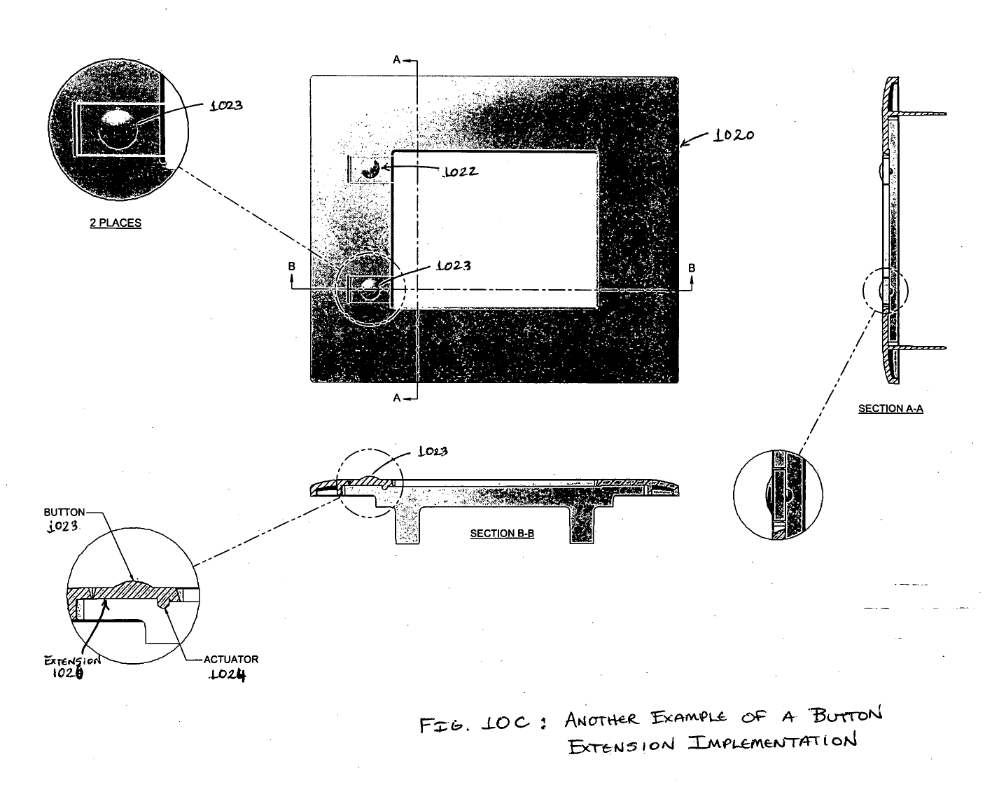

Other variations on the types of bezels that may be installed into a control user interface are also contemplated. FIG. 10A depicts a bezel 1000 that includes buttons 1002 that are arranged about the left and right periphery of the bezel 1000. In this embodiment, the buttons 1002 are positioned outside the perimeter of the touch screen 1004. However, each button 1002 includes a lateral extension 1005 that causes contact on the touch screen 1004 at a contact point 1006 when the button 1002 is pressed. In such an arrangement, a maximum of area of touch screen “real estate” is preserved by placing the buttons 1002 outside the perimeter of that “real estate” while taking advantage of the data input capability that the touch screen 1004 offers.

FIG. 10B depicts one example of an embodiment of a bezel 1010 that includes a button 1012 with a lateral extension 1016 such as may be provided in the bezel of FIG. 10A. In the example, the lateral extension 1016 extends to an actuator 1014 that contacts the touch screen. The lateral extension 1016 is connected to the bezel 1010 at an end 1018 opposite to the actuator 1014 and flexibly pivots about that opposite end 1018. In the example, the lateral extension 1016, the button 1012, and the actuator 1014 preferably are formed as a single body of a flexible material such as ABS plastic. In its natural state, the lateral extension 1016 preferably is flush against the bottom surface of the bezel 1010. When the button 1012 is pressed, the lateral extension 1016 pivots away from the bezel 1010 forcing the actuator 1014 to contact the touch screen. The lateral extension 1018 may be fastened or otherwise coupled to the bezel 1010 by any convenient means such as solvent welding or cement.

FIG. 10C depicts another example of an embodiment of a bezel 1020 that includes buttons 1022, 1023 each including an actuator 1024 connected by a lateral extension 1026 such as may be provided in the bezel of FIG. 10A. In the example, which has a button configuration similar to that depicted in FIG. 7C, the buttons 1022, 1023 and the actuator 1024 are molded as part of the bezel 1020. In the embodiment, the bezel 1020 and buttons 1022, 1023 are preferably formed of a convenient flexible material. When a button 1022, 1023 is pressed, the natural flexibility of the button 1022, 1023 causes the actuator 1024 to contact the touch screen.

Other types of bezels that are contemplated may include transparent buttons located over the periphery or the inner portion of a touch screen. In such cases, function and/or value labels may be displayed directly beneath the button and yet be clearly visible to the user. Such a configuration benefits from a conservation of space on the display and touch screen and may create additional space for providing to the user or receiving from the user additional information relating to the operation of the control system.

While aspects of the present invention have been described in terms of certain preferred embodiments, those of ordinary skill in the will appreciate that certain variations, extensions and modifications may be made without varying from the basic teachings of the present invention. As such, aspects of the present invention are not to be limited to the specific preferred embodiments described herein. Rather, the scope of the present invention is to be determined from the claims, which follow.

1. A control interface comprising:
a display screen;
a touch screen disposed on the display screen;
a processor electrically connected to the display and the touch screen;
a memory connected to the processor; and
a bezel disposed over the touch screen;
wherein the memory stores a bezel type code and the bezel type code corresponds to data regarding a type of bezel.

2. The control interface of claim 1, wherein the bezel type code identifies an installed bezel by a bezel type among a plurality of bezel types, and wherein the processor executes in accordance with an identified bezel type.

3. The control interface of claim 2, the bezel type code being communicated via a plug extending from the bezel that engages a socket electrically connected to the processor.

4. The control interface of claim 2, the bezel type code being communicated via entry of a code on the buttons of the bezel.

5. The control interface of claim 2, wherein a plurality of buttons are disposed about the periphery of the touch screen.

6. The control interface of claim 5, the display displaying adjacent to a button of the plurality of buttons a label associated with a function of a button.

7. The control interface of claim 2, a button of the plurality of buttons being transparent and disposed over the interior of the touch screen, and the display displaying a label visible through the button and associated with a function of the button.

8. The control interface of claim 2, each of the plurality of buttons being removable and comprising a button tag, the button tag for a button projecting from the button, wherein upon contacting the touch screen, the button tag communicates a button code for the button via the touch screen to the processor.

9. A control system comprising:
a plurality of electronic components; and
a control user interface electrically connected to each of the plurality of electronic components, the control user interface comprising:
a display screen;
a touch screen disposed on the display screen;
a processor electrically connected to the display and the touch screen;
a memory connected to the processor; and
a bezel disposed over the touch screen,
wherein the memory stores a bezel type code and the bezel type code corresponds to data regarding a different type of bezel.

10. The control system of claim 9, wherein the bezel type code identifies an installed bezel by a bezel type among a plurality of bezel types, and wherein the processor executes in accordance with an identified bezel type.

11. The control interface of claim 10, the bezel type code being communicated via a plug extending from the bezel that engages a socket electrically connected to the processor.

12. The control interface of claim 10, the bezel type code being communicated via entry of a code on the buttons of the bezel.

13. The control interface of claim 10, wherein a plurality of buttons are disposed about the periphery of the touch screen.

14. The control interface of claim 10, the display displaying adjacent to a button of the plurality of buttons a label associated with a function of a button.

15. The control interface of claim 10, a button of the plurality of buttons being transparent and disposed over the interior of the touch screen, and the display displaying a label visible through the button and associated with a function of the button.

16. The control interface of claim 10, each of the plurality of buttons being removable and comprising a button tag, the button tag for a button projecting from the button, wherein upon contacting the touch screen, the button tag communicates a button code for the button via the touch screen to the processor.

17. A control interface comprising:
a display screen;
a touch screen disposed on the display screen;
a processor electrically connected to the display and the touch screen, and the processor being configurable according to any one of a plurality of different types of bezels;
a memory connected to the processor; and
a bezel disposed over the touch screen having a configuration recognized by the processor.

18. The control interface of claim 17, wherein a bezel type code identifies the bezel by a bezel type among a plurality of bezel types, and wherein the processor executes in accordance with an identified bezel type.

19. The control interface of claim 17, wherein a configuration file identifies the bezel among a plurality of types of bezels, and wherein the processor executes in accordance with the configuration file.

20-35. (canceled)
